(19) United States
(12) Patent Application Publication
(10) Pub. No.: US 2015/0160940 A1
(43) Pub. Date: Jun. 11, 2015

(54) METHOD FOR CHANGING THE SOFTWARE IN THE MEMORY OF AN ELECTRONIC CONTROL UNIT

(71) Applicant: dSPACE digital signal processing and control engineering GmbH, Paderborn (DE)

(72) Inventors: Thorsten HUFNAGEL, Salzkotten (DE); Marc DRESSLER, Horn-Bad Meinberg (DE); Bastian KELLERS, Paderborn (DE)

(21) Appl. No.: 14/564,742

(22) Filed: Dec. 9, 2014

(30) Foreign Application Priority Data
Dec. 9, 2013 (EP) 13196209.4

(51) Int. Cl. G06F 9/445

(52) U.S. Cl. CPC G06F 8/65; G06F 8/67

(57) ABSTRACT

A method for changing a software in the memory of an electronic control unit. A bypass routine is stored in the working memory of the electronic control unit, and the address of the bypass function is stored in a table. A service function reads the address from the table and calls the bypass routine. The bypass routine is replaceable at the run time of the electronic control unit by erasing the table entry. The call of the service function is integrated into the program code of the electronic control unit by an overlay memory, a memory management unit, or with the aid of watch points.

This nonprovisional application claims priority under 35 U.S.C. §119(a) to European Patent Application No. 13196209.4, which was filed in Europe on Dec. 9, 2013, and which is herein incorporated by reference.

### BACKGROUND OF THE INVENTION

1. Field of the Invention

The invention relates to a method for changing the software in the memory of an electronic control unit, wherein the memory includes at least one read-only memory with multiple original program routines stored therein that constitute at least a portion of the software and that are processed by at least one processor of the control unit, and that additionally has at least one working memory for storing volatile data, wherein a bypass routine is stored on the control unit that is processed in addition to or instead of at least one original program routine, which is accomplished in that, during the course of program steps being processed by the processor, the call to a service function is made at least prior to the end of the original program routine, which service function is passed a pointer to a position in a stored table as an argument, and in the event that an entry exists in the table at this position, the bypass routine is called at the address composed of the entry, and in the event that no entry exists, the service function is terminated without calling the bypass routine.

2. Description of the Background Art

In the automotive industry, the use of software control and regulation mechanisms allows for a degree of efficiency that could not be accomplished using purely mechanical solutions. Modern automobiles thus contain a network of electronic control units (ECUs) that each have at least a processor that processes program routines, a working memory, and a read-only memory, the latter of which can be implemented in the form of a flash memory, for example.

All control units additionally have interfaces via which they receive sensor data, operate actuators, and communicate with one another. In keeping with general practice in the software industry, use of existing solutions is popular in ECU programming as well.

An already existing control unit, for example an engine control unit for an engine from a previous model, then serves as the basis for development of a new control unit. Individual functions are then selectively modified or developed from scratch, while the majority of the old code is preserved. Alternatively, manufacturers often contract with suppliers for fully programmed development control units, and then modify them in accordance with their own specific requirements. Common to both scenarios is that the newly developed functions must be integrated into the executable binary code of the control unit, where they must replace the original function in question. This integration process is referred to as bypassing.

In order to implement a function bypass, service-based bypassing is often used, for example. A service function is a special function located in the control unit's memory. It is called at specific points in the program code, and takes over technical performance of the bypass in that it calls the bypass routine, either in addition to or in place of the original function, makes the bypass routine's input quantities available, and ensures that values written by the bypass routine are stored at the correct locations in the control unit memory after the bypass routine has run.

A bypass routine can be located either on an external system or on the control unit itself. The latter possibility, so-called internal bypassing, needs less additional hardware and is not dependent on the presence of special interfaces.

A development control unit needs to be prepared for execution of a bypass. When a service-based bypass method is used, this means that a call to the service function must be integrated into the binary code before and/or after or within the function that is to be replaced.

In the ideal case, these service function calls are already implemented at the source code level. In practice, this cannot always be accomplished, which is why integration of the service function calls directly into the binary code of the original ECU application takes place in another method.

According to the current conventional art, installing new bypass code requires the flash memory of the control unit to be completely reprogrammed each time. This not only is time-consuming and interrupts ongoing test series, but it also stresses the flash memory, which is physically capable of withstanding only a limited number of storage operations.

Another problem is that many control units carry out validity testing. In order to ensure that their program code is not corrupted, they generate a checksum of their memory content and only continue to operate without restriction if this value is correct. It is only possible to install internal bypass code on such units if the checksum is updated. However, this is not possible for a user in every scenario.

In a typical scenario for service-based internal bypassing according to the prior art, a special bypass service function is present on the flash memory in addition to the actual program routine. A given program function f that is prepared for a bypass is expanded by two calls to the service.

The user installs a bypass routine on the flash memory, for example by special software, and the software enters the memory address of the bypass routine in a table. The first call to the service function is located directly before the program routine to be replaced, for example. The service function receives an index for a first table entry as an argument. If it finds a memory address there, then it calls the bypass routine that is located at this address. Otherwise, it remains passive.

The table can directly contain the memory addresses of bypass routines, or it can communicate them indirectly, for example in that it contains identification numbers that can be unambiguously associated with bypass routines installed on the system. The latter possibility is preferred primarily when one or more bypass routines are stored on external storage media that is not addressable by the processor of the control unit.

If it is executed, the bypass routine writes all the values it produces into a buffer memory. After processing the bypass routine, the processor jumps back to the actual program routine. The program routine then runs normally to the end, regardless of whether a bypass routine was executed or not.

The execution of the program routine is followed by a second call to the service function. It receives an index for a second table entry as an argument, and finds the address of an overwrite routine there. This routine is matched to the bypass routine and was installed together with it. The overwrite routine reads the results of the bypass routine from the buffer memory and, using these results, overwrites the variables written by the program routine to be replaced.

The information about the variables processed by the program routine comes from the A2L file of the control unit, for example. This is a technical description file that is provided with every development control unit. Among other things, it contains a block that associates the routines running on the control unit with the variables each one reads and writes, as well as a second block that lists the memory addresses of the variables. Knowledge of the source code of the program routines thus is not necessary for creating a bypass function.

### SUMMARY OF THE INVENTION

It is therefore an object of the invention to permit replacement of an existing program routine or an existing bypass routine without requiring a complete reprogramming of the flash memory, thus also without stressing the flash memory, in particular to permit a replacement at any time, especially including during the run time. Preferably, it should be unnecessary to change the checksum, and a rapid loading process should be possible, preferably without stopping or switching off the control unit. Replacement is understood to mean at least a functional replacement, but not necessarily a physical replacement, of the existing code of the original program routine.

In order to attain this object, the method according to an embodiment of the invention provides for the bypass routine to be transmitted, in particular through an interface of the control unit by a computer connected to the interface, into an area of the memory located outside of the read-only memory, in particular into the volatile working memory, and for the address of the bypass routine at which the bypass routine starts to be entered in the table at the position determined by the pointer.

The writing of a bypass routine into a memory area outside the read-only memory, which is to say outside the flash memory, ensures that the flash memory is not stressed, which is to say does not experience write cycles that shorten the service life.

The possibility continues to exist here, and provision is made, that a given service function call has already been implemented by the supplier by way of precaution and need not be integrated into the program code after the fact by the user, so that the problem of cyclic validity testing is obviated as well, since this relates solely to the flash memory.

The document “Microcode Patch Facility” (L. Weiss, IBM Technical Disclosure Bulletin USA, Vol. 25, No. 11A, April 1983, pp. 5624-5625), which is incorporated herein by reference, describes the transmission of a bypass routine into the working memory of a computer system and its activation by the passing of its memory address to a service function.

It is also known from the conventional art to change program code during processing by a processor by a watch point that stops the process when the processor attempts to access the code to be replaced is set ahead of the program routine to be replaced (J. Lyu et al.: A Procedure-Based Dynamic Software Update, Dependable Systems and Networks, 2001), which is incorporated herein by reference.

An advantage of the invention is that a bypass routine for replacing an original program routine or an already existing program routine can be used without stopping the control unit. Storage of the bypass routine thus preferably can also take place during the run time of the processing of the software by the processor, in particular if storage of the bypass routine takes place in the working memory.

If no (prior) bypass routine has yet been stored, then the address of the bypass routine is stored, by the user or by the software employed, in the table at the heretofore empty table position to which the pointer refers, after the first storage of a bypass routine outside the flash memory, for example in the working memory. If an overwrite routine as discussed in the above remarks is also provided in addition to the bypass routine, this likewise takes place for the heretofore empty table position to which the pointer refers that is passed to the service function as an argument for calling this overwrite routine.

In contrast, if a bypass routine and/or overwrite routine is already implemented, which is to say the relevant table position is occupied by an entry with the relevant address, then provision can be made in a further refinement of the invention that an existing entry at the position in the table determined by the pointer is deleted and/or deactivated before replacement of an existing bypass routine by a new bypass routine, and the replacement takes place during a period of time when the processor is not processing the existing bypass routine. An analogous process is followed when an existing overwrite routine is to be replaced, the replacement of which then takes place when the existing overwrite routine is not being processed.

In this case, the two table entries that contain the addresses of the bypass routine and overwrite routine are thus deleted and/or deactivated before the replacement. The service function call will thereafter find an empty entry in subsequent program cycles and remain passive, which is to say that the control unit code runs with the original program routine.

The bypass routine can then be deleted and replaced by a new bypass routine in a manner that is not time critical, which is to say in a risk-free manner. This likewise applies to a potential overwrite routine. Once the bypass routine code has been written completely into the working memory, the address of the working memory at which the bypass routine starts is entered in the table at the position determined by the pointer that is passed to the service function as an argument. The same takes place in an analogous fashion for an overwrite routine if such an overwrite routine is provided.

Alternatively, the deletion of the old bypass routine can also be omitted. A new bypass routine that then at least functionally replaces the old one can also be installed in addition to the old one in an area of the working memory that is still free. Once again, this applies in an analogous fashion for the overwrite routine as well. After complete installation, the table entries are then altered in accordance with the new valid address in question.

An embodiment ensures that an existing bypass routine is not accessed until it is no longer being executed. A deletion or manipulation of a routine that is in the midst of being executed would have grave consequences up to and including destruction of the test vehicle or test stand.

In order to ensure this, an embodiment of the method can provide that a particular status register is assigned to a bypass routine, in particular to each bypass routine, which register is set at the execution of the associated bypass routine and is otherwise erased, wherein the replacement only takes place if an existing entry in the table is erased and at the same time the status register of the bypass routine to be replaced is erased.

Another embodiment can provide that a counter is incremented at every call of a bypass routine, in particular by the service function, and the same counter is decremented at the termination of a bypass routine, and the replacement only takes place if an existing entry in the table is erased and at the same time the counter is zero. This embodiment is preferred if it is possible for multiple mutually interrupting processes or processes processed in parallel to be executed on the control unit, optionally with different priorities, so that an interruption within the additional execution of the same bypass routine or of an alternative bypass routine, or multiple simultaneous processing of one and the same bypass routine or multiple bypass routines, is possible. A counter value of zero then means that none of the processes running at a particular point in time is currently executing one of the bypass routines present at a specific stage of completion or in a further stage of completion. Provision can be made to provide not only a status register but also a counter with regard to not only bypass routines but also with regard to overwrite routines if such are present in combination with bypass routines. This measure then ensures that the processor is executing neither a bypass routine nor an overwrite routine at the time of a replacement of one or both routines.

Furthermore, provision can be made to provide a status register and a counter for all bypass and overwrite routines. This measure then ensures that the processor is not executing any of the bypass or overwrite routines that are present.

In an embodiment, it is provided that the table entry can be erased, the counter and/or the register can be queried, and depending on the counter value and/or register state, a new entry into the table takes place via software on the computer connected through the interface.

The service function calls that cause the calling of a bypass routine preferably are already implemented in a preparatory fashion at the source code level in the control unit code.

In contrast, if this does not initially take place and an original program routine is nevertheless to be replaced by a bypass routine, a further development of the invention can provide that a service function call is implemented in the program code of the control unit after the fact.

Accordingly, in order to implement a service function call not originally present in the read-only memory for a program routine, provision can be made according to the invention, in a first possible embodiment, that at least a portion of the program routine for which a bypass routine is to be stored is relocated out of the original memory area of the read-only memory into another memory area, in particular another memory area of the same read-only memory, and program branchings are provided between at least one portion of the program routine remaining in the original memory area and a relocated portion of the program routine, wherein at least one service function call is subsequently stored in the area of the original memory area freed by the relocation adjoining a remaining portion of the program routine or adjoining a relocated portion of the program routine. The adjoining with a relocated portion of the program routine can take place either at its beginning or at its end.

The program branching can take place via, e.g., jump instructions, which cause the processor to continue processing at the address specified in the jump instruction, and which refer to the address where the relocated portion of the program routine or a service function call that precedes it is stored.

Provision can further be made in conjunction with a relocation that the portion of the program routine designated for relocation is checked for address data and the address data is adapted either before or after the relocation, or that only a portion of the program routine such that it contains no address data requiring adaptation is relocated. Adaptation of address data can be done, for example, such that absolute address data items that refer to an address within the portion of the program routine designated for relocation are adapted such that after the relocation they refer to the same value or the same instruction within the relocated program routine. Conversely, adaptation can also be done such that relative data items that refer to an address outside the portion of the program routine designated for relocation are adapted such that after the relocation they refer to the same value or the same instruction outside the relocated program routine.

If a relocation to an area of the flash memory takes place, then according to an embodiment of the invention a procedure is followed such that this takes place outside the run time of the control unit in which the processor processes the software. However, if the relocation takes place to a portion of the working memory, then this can be done at run time if it is simultaneously ensured that the program routine for which relocation of a portion of the program routine is to take place is not then being processed by the processor. For this purpose the processor pointer, which points to the memory area currently being processed, can be checked to determine whether a memory area of the routine to be partially relocated is involved, for example.

Another option for after-the-fact implementation of a service function call can provide that an overlay memory of the control unit is used in order to implement a service function call not originally present in the read-only memory for a program routine, one memory address of which overlay memory is assigned via an assignment information item to a memory address of a program routine instruction of the program routine in the read-only memory that is to be replaced, so that instead of processing the program routine instruction at the address in the read-only memory, the processor processes the instruction at the assigned address in the overlay memory, and a jump instruction is stored at the assigned address in the overlay memory that causes the processor to continue program processing from an address in the working memory specified by the jump instruction, wherein at least one service function call, a reconstruction of the program routine instruction, and a jump command leading back to the original program routine are stored in a memory area of the working memory starting at this address.

Here, the invention makes use of the fact that there can be a memory area called overlay memory in control units of known design, and when the control unit's overlay function is switched on, an instruction at an address in the overlay memory that is assigned by the assignment information to the address in the read-only memory is executed instead of the instruction at the location of an address in the read-only memory.

The assignment information can be provided by the contents of processor registers or a stored table.

As a result of such an assignment that has been carried out, the program routine instruction located at the address in the read-only memory is then ignored, and in its place the jump instruction at the associated address in the overlay memory is carried out, causing the processor to branch to the working memory at the address identified by the jump instruction. Located in the area starting from this address is a service function call that, as described above, causes the processing of a bypass routine, and a reconstruction of the “overlaid” program routine instruction. In this design, the service function call can be written before or after the reconstructed program routine instruction. This is followed by a jump instruction that leads back into the original program routine, in particular to the address after the one that was overlaid.

Insertion of service function calls in this way can be done not only once, but also multiple times, which is to say also for the purpose of implementing a service function call for an overwrite routine that may be provided, for example.

This method of integrating a service function call by overlaying at least one memory address in the read-only memory with at least one assigned address in the overlay memory has the advantage that the read-only memory need not be manipulated in any way as is the case in the above-described relocation of portions of program routines.

An embodiment of this method can provide that an overlay functionality of the control unit that may be switched on if applicable is initially switched off, and subsequently, in any desired sequence, the jump instruction is stored in the overlay memory and the service function call and the said reconstruction of the overlaid instruction are integrated into the working memory to which the jump instruction refers. Only after this is done is the overlay function of the control unit switched on.

An embodiment of the invention can also provide that the bypass routine is written into a memory area outside the control unit, e.g., this can be a memory of another control unit or the memory of a computer that simulates another control unit, in particular a rapid control prototyping system.

In this case, the content at the position in the table to which the argument of the service function points does not refer to a memory internal to the control unit, but instead refers to the external memory, which can cause the control unit or the processor to transmit the data required for execution of the bypass routine to the control unit of the external memory or to the simulating computer with the external memory and execute the bypass routine stored there. This transmission can take place through interfaces and communication paths between the control units or the control unit and the simulation computer. Results of the bypass routine are then returned via communication to the control unit that executed the service function, in particular in order to overwrite the results of the original program routine with these results. To this end, the returned results can be entered in a table on the control unit and can be read from there by the service function, in particular the one that initiates the overwrite routine, in order to carry out the overwriting.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a development control unit prepared for a bypass according to the conventional art.

FIG. 2 illustrates a functionality of a service function according to the conventional art.

FIG. 3 is an excerpt from a fictitious A2L file.

FIG. 4 illustrates a development control unit prepared for a bypass according to an embodiment of the invention.

FIG. 5 illustrates a functionality of a service function according to the invention.

FIG. 6 illustrates a functionality of a service function according to the invention in an environment characterized by multiple processes.

FIG. 7 illustrates an after-the-fact integration of service calls into the machine code of the development control unit.

FIG. 8 illustrates an after-the-fact integration of service calls into the program code by utilizing an overlay memory.

### DETAILED DESCRIPTION

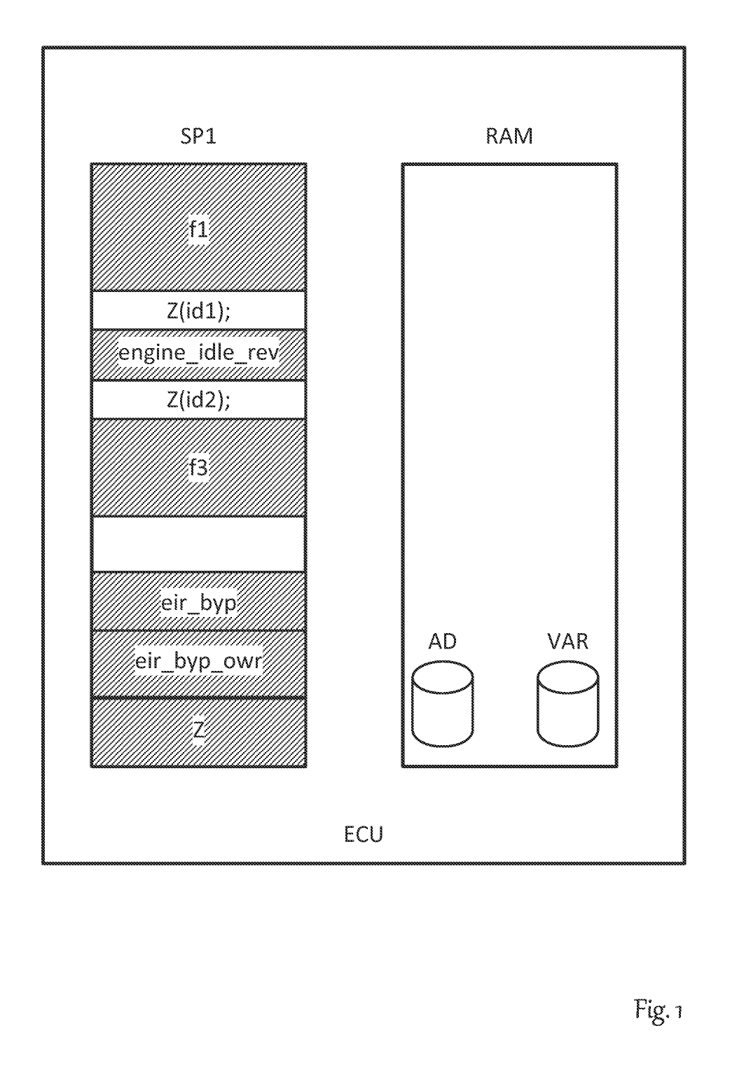

FIG. 1 illustrates the basic principle of service-based internal function bypassing. A development control unit ECU has a read-only memory SP1, as a rule a flash memory, and also has a working memory RAM. Located in the read-only memory SP1 is a program coded in machine language with multiple program routines, here comprising by way of example the routines f1, engine_idle_rev and f3. The number of routines is sharply reduced here for reasons of illustration. An actual control unit program typically has several hundred individual routines.

In one realistic example application, the control unit ECU is an engine control unit and the routine engine_idle_rev is a routine for controlling the idle speed. To reduce fuel consumption, it is useful to keep the idle speed of the engine as low as possible, or in other words, close to the speed that is just sufficient to maintain the operation of the engine.

However, this value is not a constant defined for every engine model, but instead is a variable value determined by many changeable factors. In addition to the engine model these include the state of charge of the battery, the instantaneous engine load due to electrical loads, or the engine temperature, for example.

In accordance with the many hard-to-quantify influencing factors, there is great potential for optimization. No programmer of a function for controlling the idle speed can rule out with certainty the existence of a better solution.

In one scenario an automobile manufacturer who contracts with a supplier for an engine control unit could inform the supplier that he would like to try out multiple functions for controlling the idle speed. In another scenario, he may want to extend the functionality of the control unit. For example, he may want to equip his automobile model with an automatic shutoff feature for when the vehicle is stopped. Since the function for controlling the idle speed that is present on this control unit does not have such a functionality, he wishes to replace it with his own function, and informs the supplier of this fact.

In response, the supplier stores a bypass service function Z in a free memory area of the flash memory SP1, and implements calls to the service both before and after the function engine_idle_rev that may be employed.

The passed arguments id1 and id2 are pointers to positions of a function address table AD for memory addresses of control unit functions. The service function Z checks whether the passed pointer refers to a table position with an entry of a memory address. If this is the case, the service function expects a bypass routine (in the case of id1) or an overwrite routine (in the case of id2) at this address, and calls the routine. If the applicable entry is blank, the service function Z remains passive.

According to the existing method from the prior art, the user who wishes to replace the function engine_idle_rev stored on the flash memory SP1 with a new function eir_byp stores this new function in a free area of the flash memory SP1 and enters the address of eir_byp at position id1 of the function address table AD. He also stores an overwrite function eir_byp_owr in another free area of the flash memory SP1, and enters the address of eir_byp_owr at position id2 of the function address table AD.

The bypass function eir_byp contains the actual program code. But it first writes all the values it produces into a buffer memory VAR, having a set of global variables defined especially for it, which is not accessed by any other function beyond eir_byp. Once the original function engine_idle_rev has run in due form, eir_byp_owr overwrites the variables written by engine_idle_rev with the values from the buffer memory VAR created by eir_byp.

Since the overwrite function eir_byp_owr was created specifically for the bypass function eir_byp, it knows what variable from the buffer memory VAR must overwrite what variable of the program code. If multiple bypass functions are stored on the flash memory SP1 instead of just one, each is given its own overwrite function. The information on which variables the original function engine_idle_rev processes and their memory addresses is obtained from the A2L file that accompanies the control unit.

The second service call Z(id2) that calls the overwrite function must take place after all variable write accesses in engine_idle_rev have taken place, but before any of these variables have been used in further processing. Otherwise, the program flow is not consistent. The call can take place immediately after the return statement of engine_idle_rev if it does not pass any values with its return. Otherwise, the call must take place within the function before the return statement.

In the scenario described, both the original function and the bypass function run their full course. In another scenario, for example in which the control unit ECU is executing a time-critical function, the function engine_idle_rev could also be deactivated completely. In this scenario, the bypass function could write the program variables directly instead of writing its values into a buffer memory. The second service call would then be omitted, and the service function Z could receive the address of f3 as a second argument, or could receive as argument a pointer that refers to a table position at which the address of f3 is stored. It can also execute a jump to f3 after calling the bypass function.

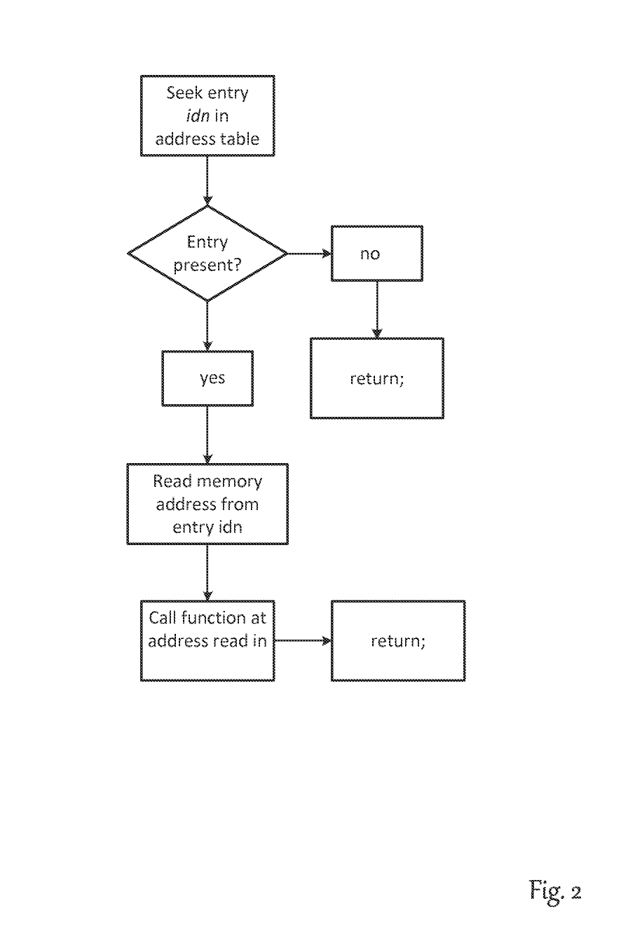

FIG. 2 shows the basic functionality of a bypass service function according to the prior art in the form of a flowchart. When called, the service is passed an argument idn, which identifies a position in a function address table AD. The service looks at this position, where it finds either a memory address or a blank entry, or as the case may be a value that does not represent a valid address and by convention represents a blank entry.

If the entry is blank, a return statement immediately occurs that terminates the service. If the service finds a memory address, it expects a function at this location, and carries out a call to this function. The bypass implementation software that is used ensures that the correct function is located at exactly this address.

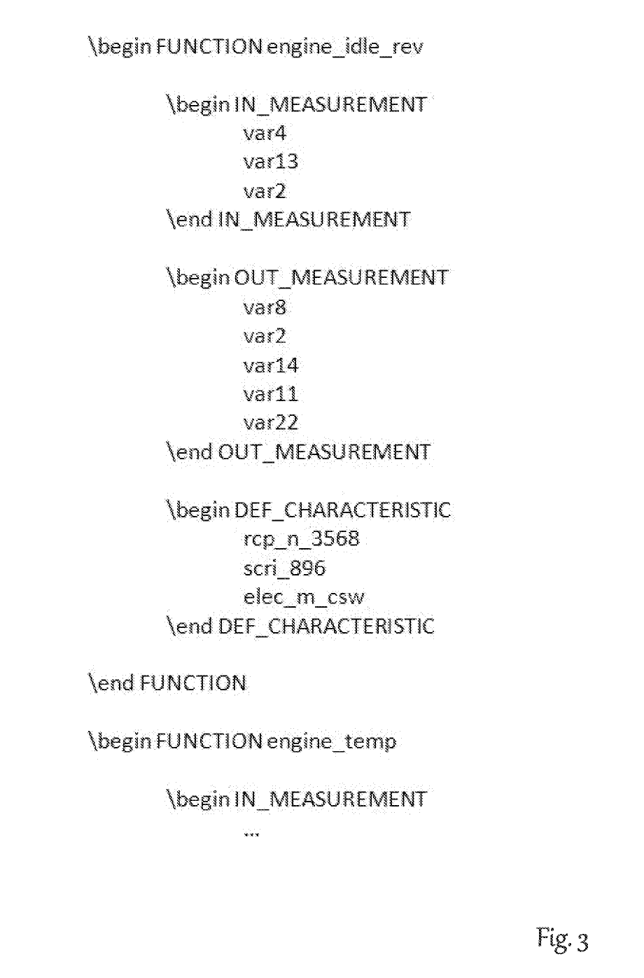

FIG. 3 shows an excerpt from a fictitious A2L file. It contains a technical description of the control unit software and is part of the scope of delivery of every development control unit. FIG. 3 shows a part of the excerpt that contains the function descriptions. A programmer who wishes to write a bypass function for the function engine_idle_rev can read here that it reads in the variables var4, var13, and var2, writes the variables var8, var2, var14, var11, and var22, and is parameterized by the setting values rcp_n_{—}3568, scri_{—}896, and elec_m_csw. The memory addresses of the variables are listed in another section of the A2L file.

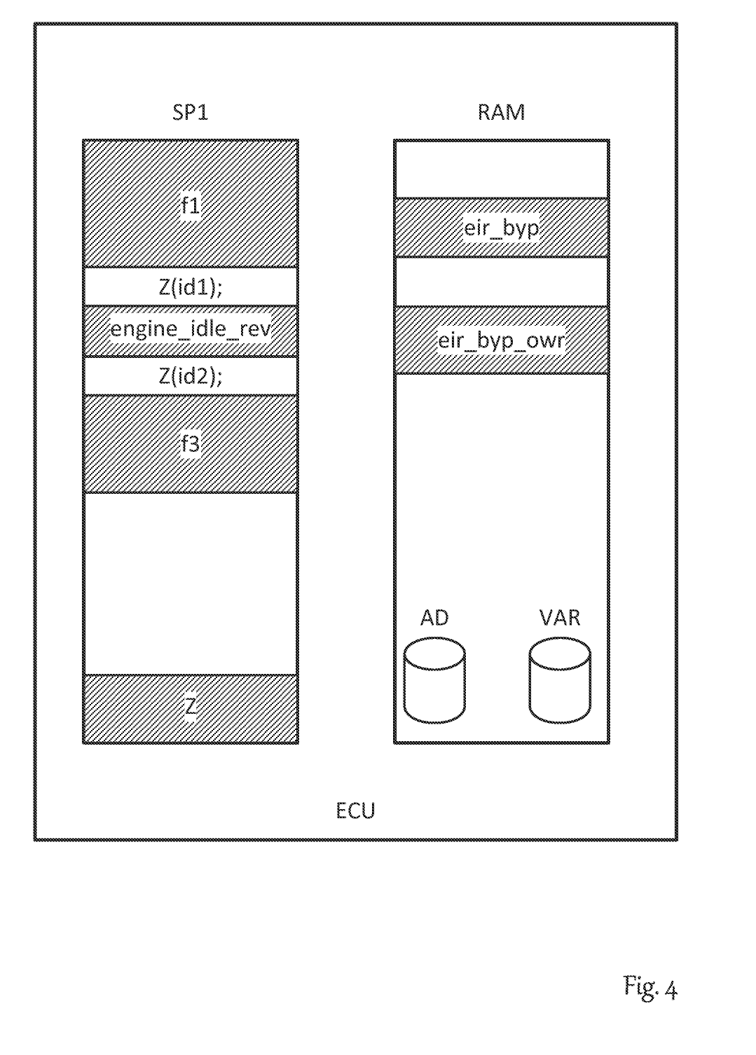

FIG. 4 illustrates the bypass scenario shown in FIG. 1 on a control unit configured according to the invention. The entire bypass functionality, which is to say the bypass routine eir_byp and the overwrite routine eir_byp_owr, are loaded not into the flash memory SP1, but instead into the working memory RAM.

The working memory is a volatile memory. Thus, its content is not retained after the control unit is switched off. On the other hand, it is fast and can be written as many times as desired. Consequently, according to the invention it is possible to replace or extend bypass routines as desired without the need to stop and reprogram the control unit.

To this end, in a preferred embodiment the entries id1 and id2 in the function address table AD are first erased. Thereafter, starting with its next call, the service function Z remains passive. The control unit code is processed according to plan, with the inclusion of the original function engine_idle_rev. The bypass routine can be erased and replaced by a new routine. Once the new routine is loaded, the corresponding addresses are written at the positions in the function address table AD corresponding to the arguments id1 and id2.

The new bypass routine can also be loaded additionally to the old bypass routine without erasing the old bypass routine. Prior erasure of the table entries can then be omitted. The entries are simply overwritten when the supplementary code is installed, preferably at a time when the prior bypass routine is not being executed, which can be determined as described in the general part.

As a result of the installation of the code in the working memory RAM, there are also no problems with validity checking, as validity checking encompasses only the read-only memory SP1. In another embodiment, provision can be made for all possible embodiments of the invention to inform the service function by a control variable that is writable from outside through an interface as to whether the bypass code should be executed. To this end, the service function tests the value of the control variable and jumps to the address to which the argument points only when a tested condition regarding this value is present.

The method according to the invention must ensure that an existing bypass routine is not erased or overwritten when it is currently being executed.

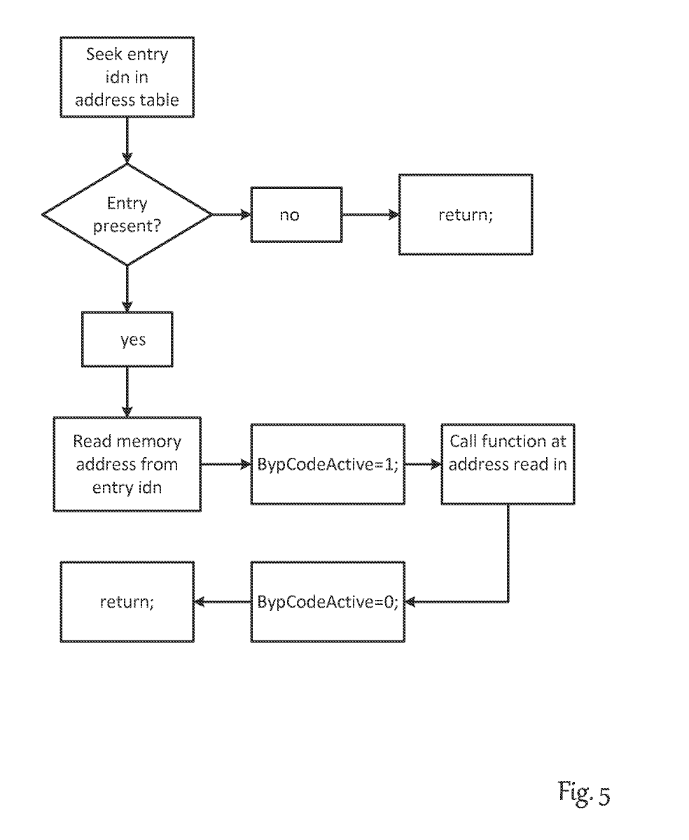

To this end, the service function Z is extended with a control function as shown in FIG. 5. A control variable BypCodeActive functions as a virtual switch or as a status register within the meaning of the foregoing general description of the invention. Prior to execution of the bypass routine it is set to one, and it is set to zero after the termination thereof. The bypass implementation software used reads the value of BypCodeActive through an interface of the control unit ECU and is configured such that it denies access to the bypass routine, thus, e.g., the overwriting, when BypCodeActive is equal to one.

The service function can also take on other functions in addition to the primary function outlined. For example, it can deregister the code located in the working memory RAM before switchoff of the control unit ECU in order to ensure that no corrupted code is executed after the next startup of the control unit.

In another embodiment, the service function detects no later than before the request for execution of a first bypass routine after the downloading or replacement of bypass routines that new routines have been downloaded but have not yet been initialized, and calls a function address configured by an entry id0. Located at the function address id0 is a function, preferably likewise downloaded dynamically by the bypass software, that carries out the initialization of the elements referenced by the bypass routine, such as global variables, for example. The service function thus ensures that the initialization function is executed first before the first call of a new set of bypass routines.

The aforementioned control mechanism is not sufficient in all scenarios. For example, it could be possible that a running bypass routine is interrupted by a second process having higher priority. If this second process then likewise executes a bypass routine, it will thereafter set BypCodeActive=0 although the stopped code has still not ended. In such a scenario, in which multiple processes can simultaneously execute bypass routines, it is necessary to ensure that no bypass routine is active in any process.

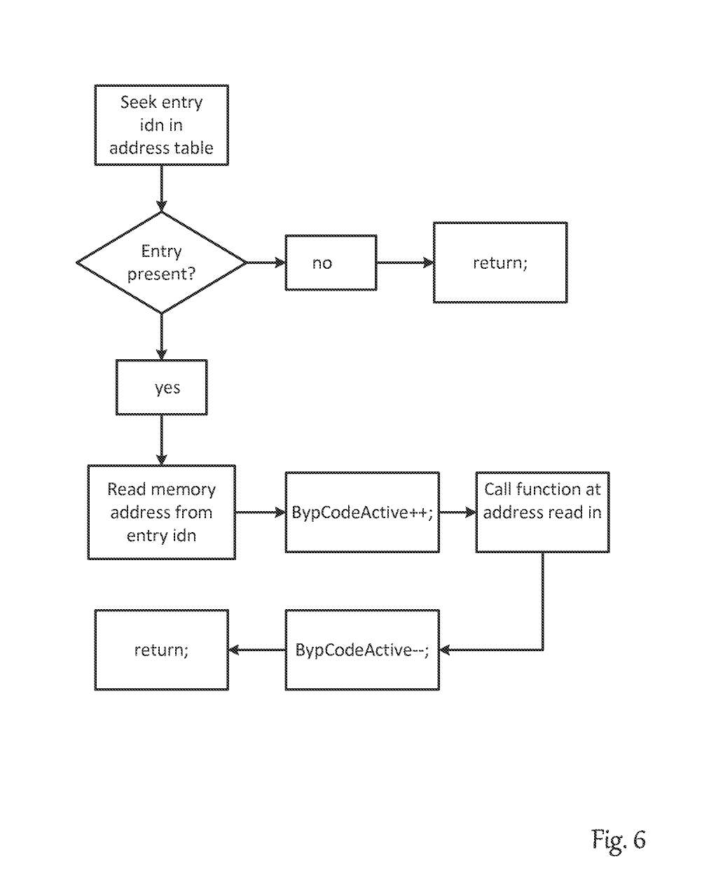

This is attained by the variant shown in FIG. 6. Here, BypCodeActive is not a binary value, hence is not a status register, but instead is an integer that is atomically incremented before execution of a bypass routine and is atomically decremented after its termination.

It can in theory take on any integer value greater than or equal to zero, and indicates with this value how many bypass routines are currently being processed. Access to a bypass routine for the purpose of replacement is only granted if BypCodeActive is equal to zero.

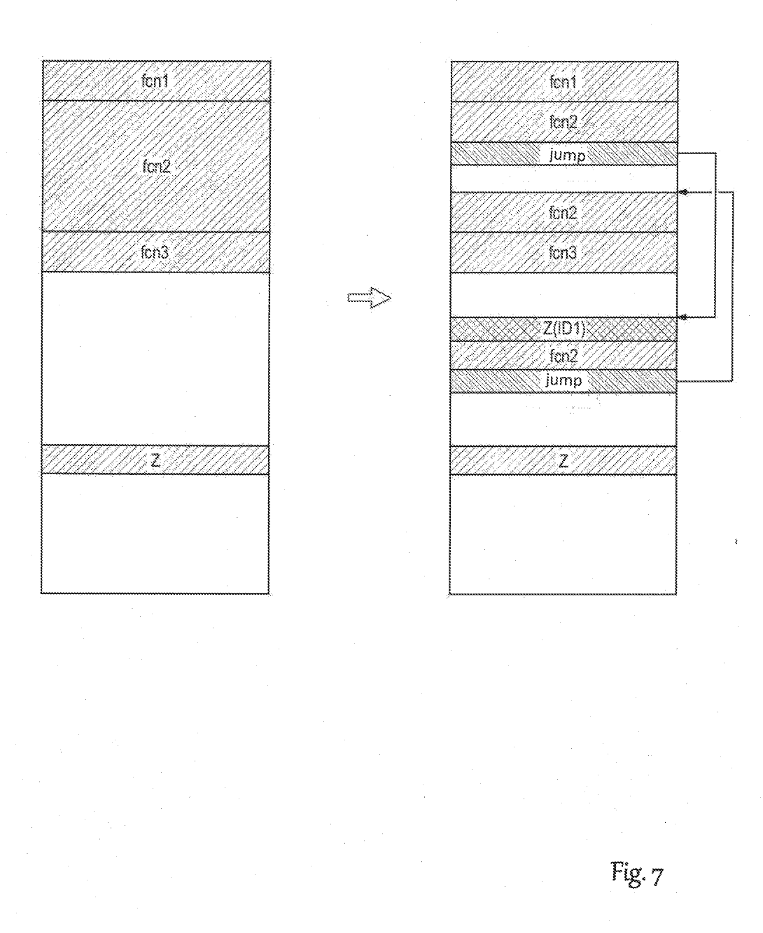

FIG. 7 shows an example of how service function calls can still be integrated into the machine code after the fact if preparation for this was not made by the manufacturer/supplier.

On the left side, FIG. 7 shows the read-only memory of a control unit. Stored therein is a program comprising three routines fcn1, fcn2, and fcn3. Also located in the read-only memory is a bypass service function Z. This can be installed there by the supplier or by the user himself. The right side shows the same read-only memory after placement of a service call in fcn2.

To this end, a portion of the code of fcn2 is displaced from the location of the desired service call to a sufficiently large free area of the read-only memory, and the service call is written ahead of it. A jump instruction referring to the service call has been written into the memory area in fcn2 that has been freed by the displacement. Another jump instruction has been written after the displaced portion of fcn2, and leads back to the intended program flow.

The bypass service function Z can already be preinstalled by the supplier of the control unit. By means of the method described, the user is in a position to implement calls to the bypass service function at any desired location in the software. He needs no access to the source code of the software for this purpose and does not depend on the participation of the supplier.

In general, the code implemented after the fact that calls the service function Z must be adapted to the control unit. The exact method for passing arguments to program functions can vary, for example according to the processor architecture, programming language, or compiler used. The bypass implementation software used to carry out the method according to the invention must therefore be able to read information about the control unit in question, for example through a special description file, and appropriately adapt the newly implemented function call.

In an embodiment of the method, the implementing software checks the code to be displaced for address data prior to displacement, and adapts these data to the displacement as necessary either before or after the displacement. In particular, adaptation is required by relative address data that refers to addresses outside the code to be displaced and absolute address data that refers to addresses within the code to be displaced. For example, if it contains a reference to a memory instruction at the position “current position—20,” and this memory instruction is not included in the displacement, then the position of this code cannot be changed without appropriately modifying the code itself. The program would not function properly thereafter. In this case, the software will refuse to execute the displacement, or in other embodiments will search for alternative, displaceable code sequences in the given region. In another embodiment, relative address data in the code portion to be displaced are appropriately adapted or are replaced with new codes or code sequences with the same functionality.

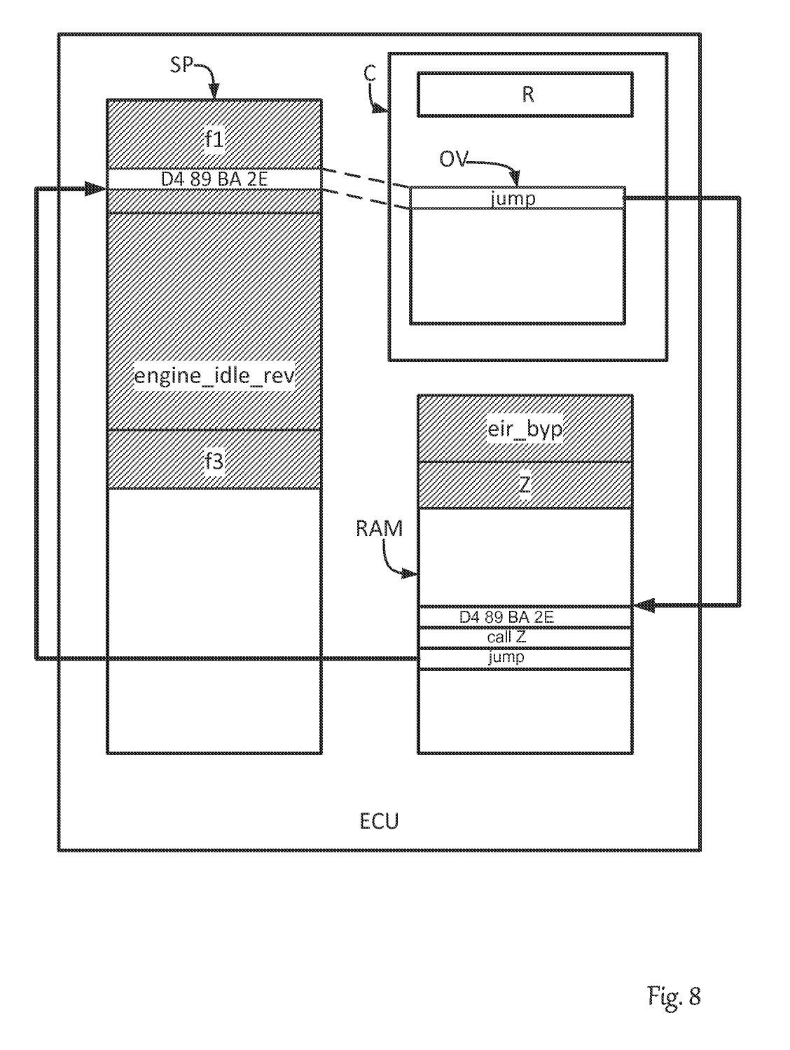

Alternatively, through the use of functionalities that development control units provide, it is possible to temporarily incorporate the required service function calls into the program code without manipulating the machine code located on the flash memory. FIG. 8 outlines this method.

Examples would be the use of the overlay memory OV, a device present in many development control units for temporarily overlaying memory contents with other contents, or the memory management unit (MMU), which permits reallocation of physical memory addresses to logical memory addresses. This can be used within the meaning of this invention in a manner analogous to the overlay memory. Like the overlay memory, this is part of the processor functionality of many development control units.

This embodiment of the method provides for overlaying a sufficiently long code sequence of the machine code with a jump instruction that refers to an address in the working memory RAM. This address marks the beginning of a code sequence that contains a reconstruction of the overlaid code and a call of the service function, wherein the call of the service function can take place before or after the reconstructed code. The code sequence ends with a jump instruction that follows the machine instruction immediately after the overlaid code sequence. The service function, like the bypass routine, is written into the working memory RAM.

However, if the control unit code contains a cyclic validity check, the checksum of the code will be changed with this method.

The use of watch points is also possible. This is a functionality that many development control units provide (albeit in a limited number). Unlike breakpoints, watch points in certain models of development control units do not simply stop the control unit at the desired point, but instead execute code that is written into a memory provided for this purpose. In this way, it is possible for the user to tie the stopping to a condition (e.g., if (x>4) break;). This monitor code may contain a wide variety of machine instructions, including service calls.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for changing software in a memory of an electronic control unit (ECU), the memory having at least one read-only memory with multiple original program routines stored therein that constitute at least a portion of the software and that are processed by at least one processor of the control unit, and additionally has at least one working memory for storing volatile data, wherein a bypass routine is stored on the control unit that is processed in addition to or instead of at least one original program routine, which is accomplished in that, during the course of program, steps are processed by the processor, the method comprising:
making a call to a service function at least prior to an end of the original program routine, which service function is optionally passed the memory address of a bypass routine;
calling by the service function a corresponding bypass routine when a memory address is passed and terminating without calling a bypass routine if no memory address is passed;
transmitting the bypass routine through an interface of the control unit via a computer connected to the interface into an area of the memory located outside the read-only memory or into the volatile working memory; and
passing the service function the address at which the bypass routine begins;
deactivating the calling of the bypass routine by the service function;
replacing the bypass routine with a new bypass routine during a period of time when the processor is not processing the bypass routine; and
activating the calling of the bypass routine by the service function,
wherein the deactivating step, the replacing step, and the activating step are performed during a run time of the processing of the software by the processor.

2. The method according to claim 1, wherein the passing of the memory address of the bypass function to the service function takes place such that the service function is passed a pointer to a position in a stored table, and when an entry is present at this position in the table the bypass routine is called at the address formed by the entry, and when an entry is absent or marked as invalid the service function is terminated without calling the bypass routine.

3. The method according to claim 1, wherein storage of the bypass routine takes place during the run time of the processing of the software by the processor.

4. The method according to claim 2, wherein an existing entry at the position in the table determined by the pointer is erased or marked as invalid before the replacement of an existing bypass routine by a new bypass routine.

5. The method according to claim 4, wherein a particular status register is assigned to a bypass routine or to each bypass routine, which register is set to a first value at the execution of the associated bypass routine and is otherwise set to a second value or is erased, and wherein the replacement only takes place if an existing entry in the table is erased or marked as invalid and at the same time the status register of the bypass routine to be replaced is set to the second value or is erased.

6. The method according to claim 4, wherein a number of processes that are processing a bypass routine or the bypass routine to be replaced at a given point in time is monitored by a counter such that a counter is incremented at every call of a bypass routine by the service function, and the same counter is decremented at the termination of a bypass routine, and the replacement only takes place if an existing entry in the table is erased or marked as invalid and at the same time the counter is at a starting value, preferably zero.

7. The method according to claim 4, wherein, via a piece of software and/or hardware, in particular an influencing device, the table entry is erased, the counter/the register is queried, and depending on the counter value or register state a new entry into the table takes place.

8. The method according to claim 1, wherein, in order to implement a service function call not originally present in the read-only memory for a program routine, an overlay memory of the control unit is used, at least one memory address of which is assigned by an assignment information item to a memory address of a program routine instruction of the program routine in the read-only memory that is to be replaced, so that instead of processing the program routine instruction at the address in the read-only memory, the processor processes the instruction at the assigned address in the overlay memory, and a jump instruction is stored at the assigned address in the overlay memory that causes the processor to continue program processing from an address in the volatile or nonvolatile working memory specified by the jump instruction, wherein at least one service function call, a reconstruction of the program routine instruction, and a jump command leading back to the original program routine are stored in a memory area of the working memory starting at this address.

9. A method for changing the software in the memory of an electronic control unit, wherein the memory includes at least one read-only memory with multiple original program routines stored therein that constitute at least a portion of the software and that are processed by at least one processor of the control unit and that additionally has at least one working memory for storing volatile data, the method comprising:
storing a first bypass routine on the control unit that is processed in addition to or instead of at least one original program routine, which is accomplished in that, during the course of program steps being processed by the processor, the call to a service function is made at least prior to the end of the original program routine;
passing the service function a memory address of a bypass routine;
calling, via the service function, a corresponding bypass routine when a memory address is passed and terminating it without calling a bypass routine if no memory address is passed;
transmitting the first bypass routine through an interface of the control unit by a computer connected to the interface into an area of the memory located outside the read-only memory or into the volatile working memory; and
passing to the service function the address at which the first bypass routine begins;
transmitting, during a run time of processing of the software by the processor, a second bypass routine into an area of the memory located outside the read-only memory or into the volatile working memory in addition to the first bypass routine; and
passing to the service function an address at which the second bypass routine begins.
